(19) United States
(12) Patent Application Publication
(10) Pub. No.: US 2026/0109123 A1
(43) Pub. Date: Apr. 23, 2026

(54) DEVICE FOR PRESSING MATERIAL

(71) Applicant: Berndorf Band GmbH, Berndorf (AT)

(72) Inventor: Karl MORGENBESSER, Aspang (AT)

(73) Assignee: Berndorf Band GmbH, Berndorf (AT)

(21) Appl. No.: 18/724,684

(22) PCT Filed: Dec. 28, 2022
(86) PCT No.: PCT/AT2022/060465

§ 371 Date: Jun. 27, 2024

(30) Foreign Application Priority Data
Dec. 28, 2021 (AT) A51049/2021

(51) Int. Cl. B30B 5/06; B30B 15/00

(52) U.S. Cl. CPC B30B 5/062; B30B 15/0088

(57) ABSTRACT

A device for pressing material includes a control device, at least one first endless band forming a first presser; and at least one second presser. A pressing zone for pressing material is formed between the first endless band and the second presser and a longitudinal direction parallel to the first endless band is defined in a direction with respect to the pressing zone, from beginning to end of the pressing zone. By at least one pressure-exerting device, a pressing pressure on the at least one first endless band inner surface that is directed away with respect to the pressing zone can be built up in the direction of the pressing zone. The pressure-exerting device is designed so that at least one fluid can be applied onto the at least one first endless band inner surface in the direction of the pressing zone to build up the pressing pressure.

The invention relates to a device for pressing material, e.g. material containing fibers.

The device comprises at least one first endless band, which forms a first pressing means, and at least one second pressing means, in particular a second endless band, wherein a pressing zone for pressing material is formed between the first endless band and the second pressing means and a longitudinal direction is defined, wherein the longitudinal direction is arranged parallel to the first endless band and in a direction relative to the pressing zone, starting from a beginning of the pressing zone to an end of the pressing zone.

In an operational status of the device, the material is conveyed in the direction of rotation of the endless band towards the pressing zone, where it is subsequently pressed.

In this respect, at least one pressure-exerting device is provided, by means of which a pressing pressure can be built up on an inner surface of the at least one first endless band in the direction of the pressing zone, which inner surface faces away from the pressing zone.

Such devices are widely used in the state of the art and include various pressure-exerting devices, e.g. pressure rollers, by means of which the material is pressed in the pressing zone.

A disadvantage of embodiments according to the state of the art is that the pressure-exerting devices and possible friction often lead to abrasion and even damage and premature wear of the endless band, resulting in reduced process stability and efficiency of the device.

The object of the present invention was to overcome the disadvantages of the prior art and to provide a device by means of which a user is able to minimize wear and tear of the endless band and to ensure a longer service life.

This object is achieved by a device and a method according to the claims.

The device according to the invention is characterized in that the pressure-exerting device is designed in such a way that at least one fluid can be applied onto the inner surface of the at least one first endless band in the direction of the pressing zone, by means of which fluid the pressing pressure can be built up.

The configuration according to the invention largely prevents wear of the endless band by the pressure-exerting device, since the pressing pressure can be built up by a fluid and solid contact on the inner surface of the endless band in the pressing zone is prevented.

In a further embodiment, it may be provided that at least one spacer element is provided, which spacer element is located downstream of a fluid outlet of the pressure-exerting device with respect to a flow direction of the fluid, by means of which spacer element a lubrication gap can be formed on the inner surface of the endless band for the fluid. One advantage is that the lubrication gap of the spacer element makes it easy to maintain the pressing pressure downstream of the pressure-exerting device. Furthermore, a distance between the pressure-exerting device and the endless band can be more easily determined and adjusted using a spacer element.

By way of introduction, it should be noted that a lubrication gap or a lubrication film of the device according to the invention in the area or within the pressing zone does not only mean a simple wetting of the inner surface of the endless band, but that it may also be a fluid film which forms a considerably larger filling level on the endless band. Seals may preferably be provided to laterally limit the lubrication film so that unintentional leakage of the fluid from the endless band can be prevented. Furthermore, the spacer element may also be used to form the lubrication film after the pressing zone for the rotating endless band.

A flow direction of the fluid refers to the path that is created by the application or flow of the fluid in the direction of the pressing zone and can then be guided further in the transport direction of the endless band.

One possible embodiment is characterized in that the at least one spacer element comprises a frame arrangement, wherein the frame arrangement is arranged between the pressure-exerting device and the inner surface of the endless band and is provided with at least one fluid passage, the fluid passage being formed in the direction, starting from the pressure-exerting device towards the inner surface. A frame arrangement may be used to create a simple means of attaching different pressure-exerting devices or pressure vessels to the frame, which is always adapted to the width of the endless band. A frame also makes it easier to apply sealants for a fluid.

The fluid passage is used to apply the fluid through the spacer element or the frame arrangement onto the inner surface of the endless band and may form an extension of the fluid outlet of the pressure-exerting device.

Preferably, the frame arrangement may be provided with at least one further fluid passage, the at least one further fluid passage being formed in at least one frame segment. The advantage of this configuration is that the frame can, for example, provide the frame areas facing the inner surface of the endless band with lubricant by means of the fluid passage. The fluid passage may be formed by an opening or a channel, for example. In one configuration, the pressing zone may be formed with the frame arrangement, whereby only the lubrication of the belt takes place by means of the additional fluid passage.

Furthermore, it may be provided that the spacer element is at least partially formed from a porous material, the porous material being penetrable by the fluid in at least one direction. By means of this configuration, the area under the spacer element or the area downstream of the spacer element with respect to a flow direction may be provided with lubricant or the fluid by simple means.

It should be mentioned that the porous material may preferably be selected in such a way that the porosity of the material allows the fluid to seep through, but does not significantly affect the pressing pressure of the pressure-exerting device.

In a possible advancement, it may be provided that the at least one spacer element is wedge-shaped with respect to the longitudinal direction, so that a gap width between the spacer element and the inner surface of the first endless band decreases with respect to the longitudinal direction. The advantage of this configuration is that the fluid may be conveyed more easily or in a targeted manner in the longitudinal direction through the endless band if, for example, a turbulent flow occurs when it exits the pressure-exerting device.

Furthermore, it may be provided that the spacer element comprises a rolling body, in particular a cylindrical roller, which rolling body is rotatably mounted with respect to an axis of rotation, which axis of rotation is orthogonal to the longitudinal direction and substantially parallel to the inner surface of the first endless band. Another advantage here is the targeted deflection of the fluid in the longitudinal direction by rolling the rolling body.

Furthermore, it may be provided that an adjustment device is provided, by means of which adjustment device a distance between the inner surface of the first endless band and the pressure-exerting device can be adjusted. This configuration has the advantage that, for example, the pressure-exerting device can be brought closer to the endless band if the latter moves away from the pressure-exerting device due to the pressing pressure. However, it may also be provided that the distance of the pressure-exerting device can be adjusted with regard to a regulation of the pressing pressure if the pressing pressure can be produced, for example, by a gravity pressure.

In one possible configuration, it may be provided that the spacer element is height-adjustable, wherein a distance between the spacer element and the inner surface of the first endless band is adjustable. The advantage of this measure is that a lubrication gap can be controlled, for example, depending on the rotational speed of the endless band or the pressing pressure of the pressure-exerting device.

It is also possible that the pressure-exerting device is arranged over the entire pressing zone. This configuration is advantageous, for example, if the pressing zone is relatively short, e.g. with a pressure roller as the second pressing means.

In a possible advancement, it may be provided that the fluid is gaseous or liquid, the fluid comprising in particular water or oil. One advantage of this measure is that the pressing pressure can be built up with compressed air or a gas, for example, and therefore simple structural measures can be taken. When using liquid fluids, in particular water or oil, a cost-effective embodiment is formed and a lubricant can be provided for the endless band at the same time.

It may be particularly advantageous if at least one sealing body arrangement is provided at least in the pressing zone, the sealing body arrangement being arranged at least on the inner surface of the endless band. This configuration has the advantage of being able to prevent undesired fluid leakage into the designated area.

Furthermore it may be provided, that the at least one sealing body arrangement is arranged in the pressing zone at least on the inner surface of the first endless band with respect to a direction transverse to the longitudinal direction on a first edge section and an opposite second edge section of the first endless band, the sealing body arrangement being arranged with respect to the longitudinal direction at least over a length of the pressing zone. This advantageous configuration ensures that the fluid is limited or sealed in a direction transverse to the longitudinal direction, which makes it easier to maintain the pressing pressure.

In an advancement, it may be provided that the at least one sealing body arrangement comprises a pushing device by means of which the sealing body arrangement can be pressed against the at least one first endless band. This measure can improve the sealing effect and optimize the adaptation of the sealing body arrangement to an endless band deformed by the pressing pressure.

It may be advantageous if the spacer element and/or the frame arrangement comprises the at least one sealing body arrangement. This measure can ensure an improved seal in the area of the pressing zone. In addition, the spacer element can, for example, in one possible embodiment be formed by the sealing body arrangement, which is arranged transversely to the longitudinal direction, for example with a pushing device, whereby a lubrication gap of the spacer element can additionally be controllable by the pushing device. In addition, the frame arrangement may also comprise or be formed by several sealing body arrangements.

Furthermore, it may be provided that the control device is configured to adjust the pressing pressure of the pressure-exerting device depending on a rotational speed of the first endless band. This configuration contributes to an optimization of the pressing behavior.

Furthermore, it may be provided that the control device is configured to adjust the distance between the inner surface of the at least one first endless band and the pressure-exerting device depending on a rotational speed of the first endless band. This configuration may be particularly advantageous if, for example, the pressing pressure is built up and regulated with a gravity pressure of the fluid.

It may be advantageous if the control device is configured to control a pushing pressure of the pressure-exerting device on the sealing body arrangement depending on the pressing pressure of the pressure-exerting device and/or a quantity of fluid introduced into the lubrication gap and serving as lubricant. This measure makes it possible to dynamically adjust the sealing behavior depending on the pressing pressure. It is also possible to configure the dimensions of the lubrication gap.

For the purpose of better understanding of the invention, this will be elucidated in more detail by means of the figures below.

These show respectively in a very simplified schematic representation:

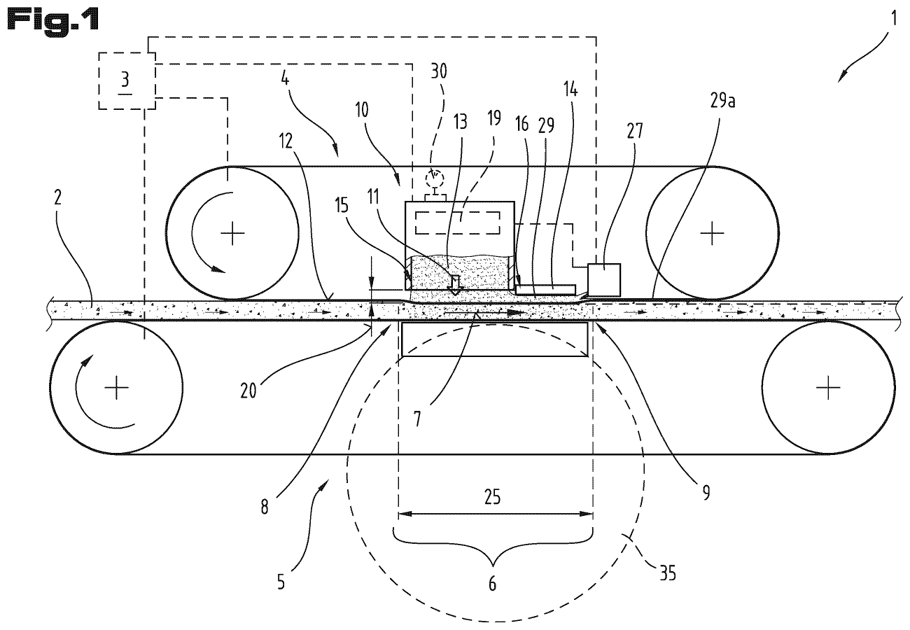

FIG. 1 a device according to the invention for pressing material:

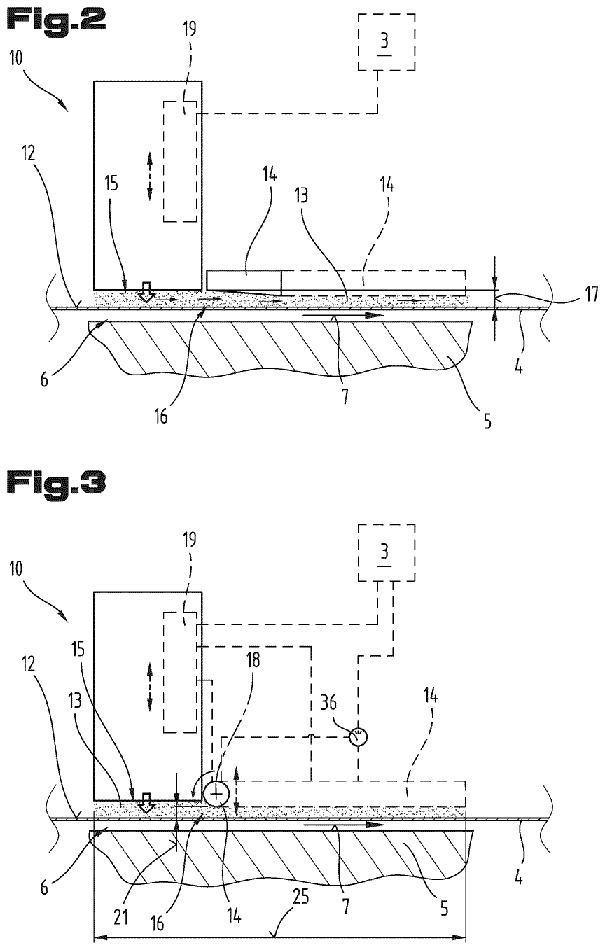

FIG. 2 a possible embodiment of a spacer element;

FIG. 3 another possible embodiment of a spacer element;

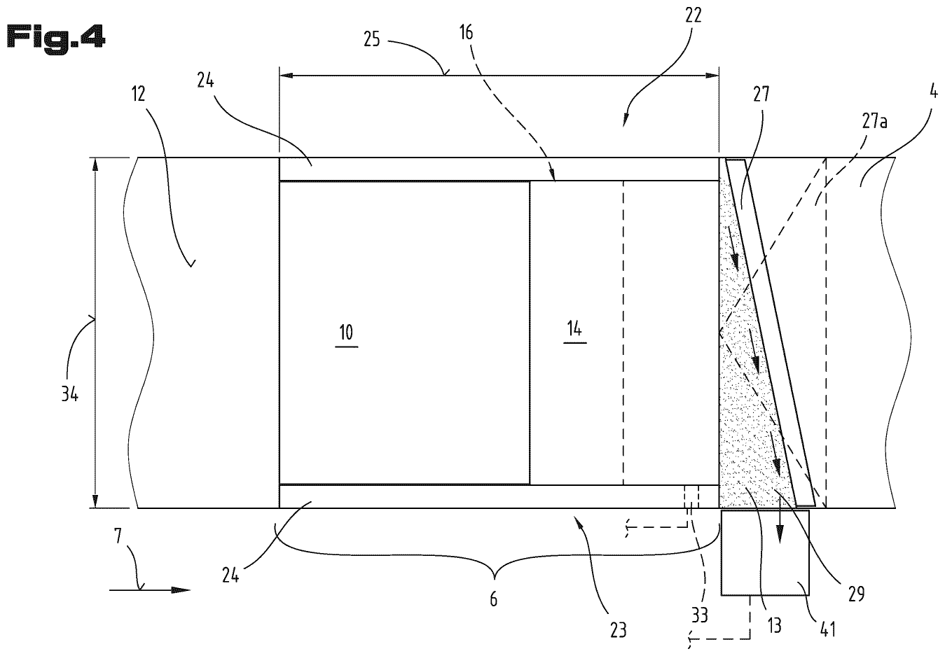

FIG. 4 a top view of an inner surface of an endless band:

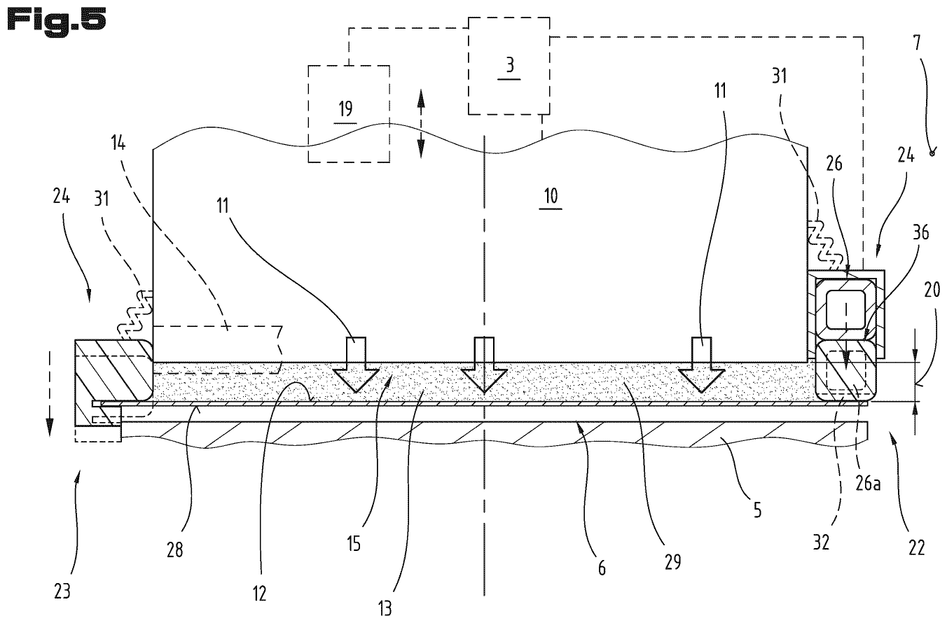

FIG. 5 a cross-section of an endless band with a sealing body arrangement;

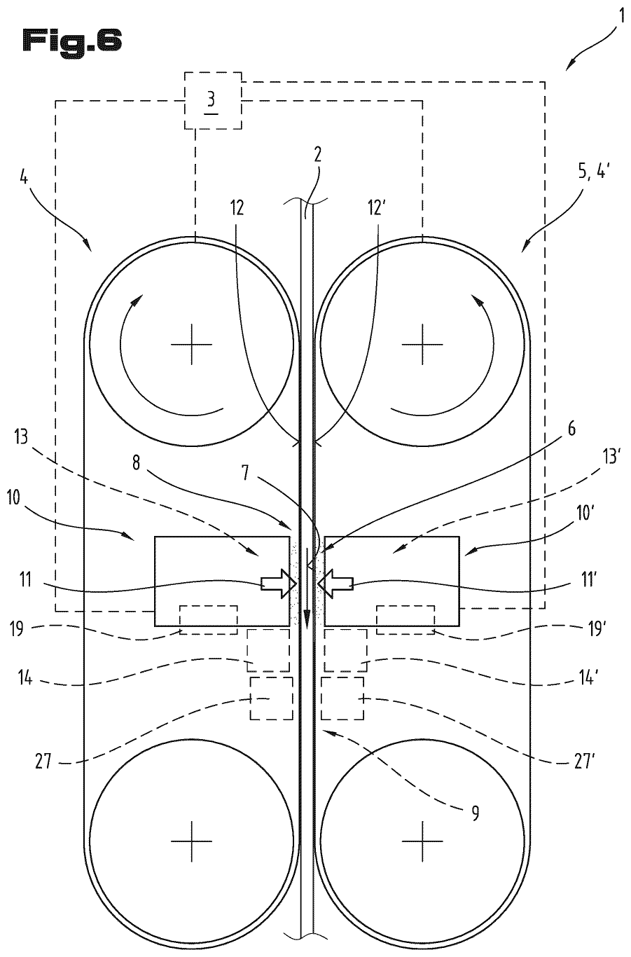

FIG. 6 a possible embodiment of a device for pressing material;

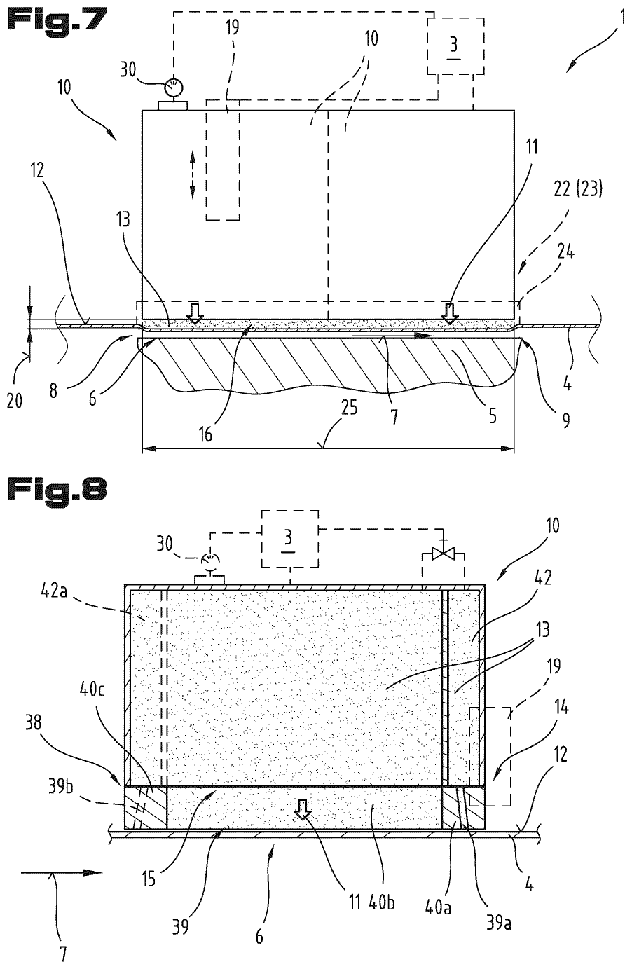

FIG. 7 a possible embodiment of the pressure-exerting device;

FIG. 8 an embodiment of a spacer element in sectional view:

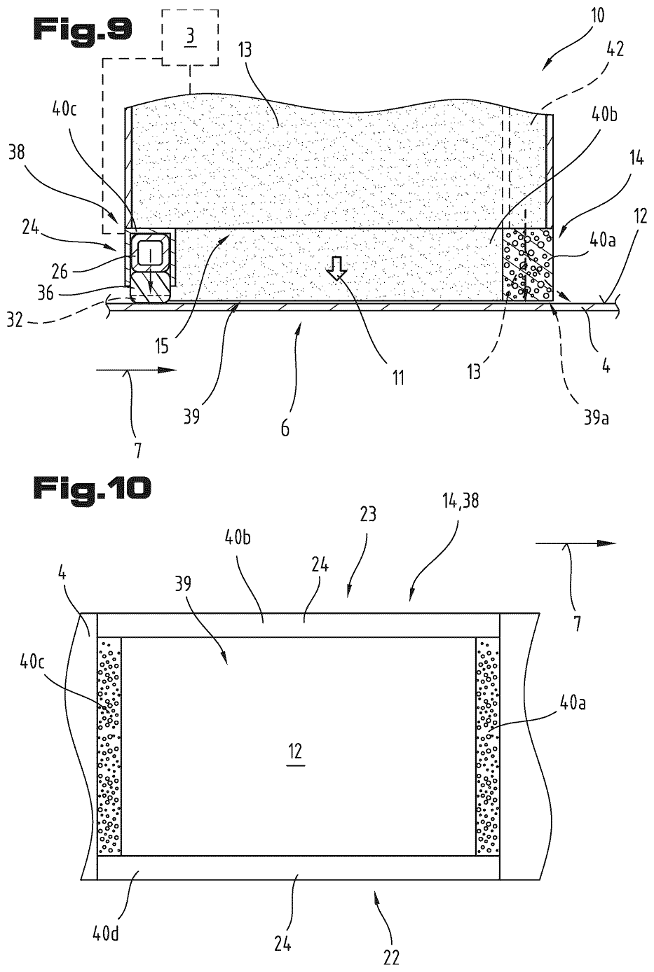

FIG. 9 another possible embodiment of a spacer element;

FIG. 10 a top view of a possible embodiment of a frame arrangement of a spacer element with the pressure-exerting device not shown.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a device 1 for pressing material 2, in particular material containing fibers, which device 1 comprises a first endless band 4, which first endless band 4 forms a first pressing means, and a second pressing means 5, which as shown may also be formed as an endless band. Preferably, a control device 3 is provided to control the device 1.

A pressing zone 6 for pressing material 2 is formed between the first endless band 4 and the second pressing means 5. A longitudinal direction 7 is provided, which longitudinal direction 7 is arranged parallel to the first endless band 4 and in a direction with respect to the pressing zone 6, starting from a beginning 8 of the pressing zone 6 to an end 9 of the pressing zone 6. In an operational status of the endless band 4, the longitudinal direction 7 also corresponds to a conveying direction of the material 2 in the pressing zone 6, which is created by conveying the material 2 through a rotating first endless band 4. The first endless band 4 may be mounted on at least two rollers, at least one of which may be driven.

The second pressing means 5 may also be formed by a second endless band, as shown, which is driven by at least one roller, for example. However, the second pressing means 5 may also be configured as a pressure roller 35 as indicated by a stroke-dotted line, or as a sliding surface or otherwise. Depending on the configuration of the second pressing means 5, a length 25 of the pressing zone 6 may vary accordingly.

As shown, the second endless band may be provided with a counterpressure element in the pressing zone 6, so that the second endless band withstands a pressing pressure better. The two endless bands may also be supported or guided by more than two rollers.

Furthermore, a pressure-exerting device 10 is provided, by means of which pressure-exerting device 10 a pressing pressure 11 can be built up on an inner surface 12 of the first endless band 4 in the direction of the pressing zone 6, which inner surface 12 faces away from the pressing zone 6.

According to the invention, at least one fluid 13 can be applied onto the inner surface 12 of the first endless band 4 in the direction of the pressing zone 6 by means of the pressure-exerting device 10, by means of which fluid 13 the pressing pressure 11 can be built up.

The fluid 13 may preferably be configured as a liquid and have known lubricant compositions, which are known from the prior art for the above-mentioned devices.

Irrespective of the embodiment of the device 1 shown, the pressure-exerting device 10 may for example comprise at least two fluids 13, wherein a first fluid may for example be provided for “slow” operation or start-up of the device and may have improved lubricating properties at low speeds and a second fluid is provided for the operational status at increased speeds and has improved running properties for this.

In this respect, an external supply may be provided which supplies the pressure-exerting device with fluid.

The endless band 4 behaves in relation to the pressure-exerting device 10 in a similar way to a hydrodynamic slide bearing, wherein a lubricating wedge is formed between the pressure-exerting device 10 and the rotating first endless band 4.

Similar to a slide bearing, where, for example, a shaft distances itself from the bearing shell in the operational status by means of entrained lubricant, the first endless band 4 also entrains the fluid 13 in the longitudinal direction 7 by means of fluid friction and thereby distances itself from the pressure-exerting device 10 or downstream components, such as a spacer element.

In one area of the pressure-exerting device 10, the pressing pressure 11 on the inner surface 12 may be produced with a gravity pressure or a process pressure of the fluid 13. For example, the pressure-exerting device 10 may comprise pressing means by means of which the fluid 13 can be subjected to a process pressure. In this respect, further pressing means may be provided by means of which the pressure of the pressure-exerting device can be monitored and also adjusted. In a possible advancement, the control device 3 may be configured to adjust the pressing pressure 11 of the pressure-exerting device 10 depending on a rotational speed of the first endless band 4.

Components may be provided downstream of a fluid outlet 15 of the pressure-exerting device 10 with respect to the longitudinal direction 7, by means of which components and a formed lubrication film 29 of the fluid 13 a sustained pressing pressure can be exerted on the endless band. For example, a plate may be positioned downstream, which plate has a plate width that is essentially smaller than or equal to the width of the first endless band 4, so that pressure is maintained on the endless band between the plate and the belt by means of the fluid 13. Alternatively, the pressure-exerting device 10 itself may also be arranged over the entire pressing zone 6 or the length 25 of the pressing zone 6. As shown, the lubrication film 29 in the pressing zone 6 may form a higher filling level of fluid quantity on the endless band 4 than a lubrication film 29a downstream of the end 9 of the pressing zone 6.

For the sake of completeness, it should be mentioned here that the illustrated pressing zone 6 and its length 25 are for illustrative purposes only and may be arranged over a smaller or larger area of the endless band 4. An exaggerated deformation of the endless band 4 due to the pressing pressure is also illustrated for easier understanding.

As indicated by a stroke-dotted line, an adjustment device 19 may be provided in an area of the pressure-exerting device 10, by means of which adjustment device 19 a distance 20 between the inner surface 12 of the first endless band 4 and the pressure-exerting device 10 can be adjusted. In an advancement, the distance 20 can be adjusted by means of the control device 3 depending on the rotational speed of the first endless band 4.

In a first and second edge section of the endless band opposite the longitudinal direction 7, preferably sealing body arrangements may be arranged for a lateral limitation of the fluid film, which sealing body arrangements will be discussed in more detail later.

Furthermore, a fluid collector 27 may be arranged after the pressing zone 6, which can collect at least a partial quantity of the fluid 13 so that no excess lubricant remains on the endless band after the pressing zone 6. The fluid collector 27 may be configured as a type of scraper device, which guides a collected fluid quantity into a collection container or returns it to a circuit of the pressure-exerting device 10.

Furthermore, at least one spacer element 14 may be arranged, which spacer element 14 is arranged downstream of a fluid outlet 15 of the pressure-exerting device 10 with respect to a flow direction of the fluid. The spacer element 14 may be used to form a lubrication gap 16 on the inner surface 12 of the endless band 4 for the fluid 13. Preferably, the spacer element 14 extends over a width of the endless band, with respect to which width the fluid forms a lubrication film 29. If there is no additional component downstream of the spacer element 14 to maintain the pressure or a lubrication gap, the spacer element 14 may also extend to the end 9 of the pressing zone 6 or even form its end.

In one possible embodiment, the spacer element 14 may be firmly connected to the pressure-exerting device 10 and may be adjusted with it by the adjustment device 19. In another embodiment, the spacer element 14 may be arranged as a separate component and be adjustable. As mentioned at the beginning, the spacer element may also comprise a frame arrangement, which is arranged between the pressure-exerting device and the inner surface of the endless band and is provided with a fluid passage. The said frame arrangement will be discussed in more detail later.

FIG. 2 shows a possible embodiment of a spacer element 14. The spacer element 14 is wedge-shaped with respect to the longitudinal direction 7, so that a gap width 17 between the spacer element 14 and the inner surface 12 of the first endless band 4 decreases in the direction of the longitudinal direction 7. The pressure-exerting device 10 may comprise several spacer elements 14, as shown.

FIG. 3 shows a further possible embodiment of a spacer element 14.

In the embodiment shown, the spacer element 14 is configured as a rolling body and is rotatably mounted with respect to an axis of rotation 18, which axis of rotation 18 is orthogonal to the longitudinal direction 7 and substantially parallel to the inner surface 12 of the first endless band 4. This configuration has the advantage of forming a lubrication gap and at the same time preventing the fluid 13 or lubricant from accumulating in front of the spacer element 14, caused by the fluid being entrained along by the rotating endless band.

Irrespective of the illustrated embodiment of the spacer element 14 in FIGS. 2 and 3, the spacer element 14 may be configured to be height-adjustable, wherein a distance 21 between the spacer element 14 and the inner surface 12 of the first endless band 4 may be adjusted, as indicated in FIG. 3. The height may be adjusted, for example, using the adjustment device 19.

Furthermore, a pressure monitoring unit 37 may be provided for the spacer element 14, by means of which a pressure between the spacer element 14 and the inner surface 12 of the endless band 4 or also a pressure which the fluid 13 exerts on the spacer element 14 is monitored, which pressure monitoring unit 37 may transmit a value to the control device 3, by means of which value in turn an adjustment of the distance 21 may be made.

FIGS. 4 and 5 show possible embodiments and the arrangement of a sealing body arrangement 24 in plan view and sectional view.

FIG. 4 shows a plan view of the inner surface 12 of the endless band 4, wherein at least one sealing body arrangement 24 is arranged on the inner surface 12 in a direction transverse to the longitudinal direction 7 on a first edge section 22 and an opposite edge section 23 of the endless band 4, which sealing body arrangement 24 is arranged with respect to the longitudinal direction 7 at least over the length 25 of the pressing zone 6. The sealing body arrangement 24 is preferably in sealing contact with the pressure-exerting device 10, or may be flexibly connected to it, so that the sealing effect is ensured in the event of a possible adjustment of the pressure-exerting device 10. Depending on the configuration of the pressure-exerting device 10, the sealing body arrangement 24 may also be in sealing contact with a spacer element 14 or connected to it.

In an embodiment not shown, it is also conceivable that the sealing body arrangement 24 is firmly connected to the pressure-exerting device 10 or the spacer element 14 if these are not configured to be adjustable.

Furthermore, irrespective of the configuration of the sealing body arrangement 24, a fluid collector 27 may be arranged, which, as shown, is configured as a scraper and may, for example, be arranged inclined between the two edge sections 22, 23, so that the fluid 13 is diverted in the direction of an edge section, where the fluid 13 can be collected again, for example into a tank or container 41 and can be returned to a circuit to the pressure-exerting device 10. With regard to the fluid collector 27, the sealing body arrangement 24 may also provided with an outlet opening 33 in an area of the fluid collector, by means of which outlet opening 33 the fluid can be returned to a circuit. The fluid collector 27a may also have other geometric shapes, e.g. the form of a triangle, as indicated by a stroke-dotted line.

As may be seen from the illustration in FIG. 4, the pressure-exerting device 10 or a possible spacer element 14 is preferably configured such that they extend essentially along a width 34 of the endless band 4 as far as the sealing body arrangements 24 in order to ensure optimum pressure distribution.

FIG. 5 shows a cross-section through a first endless band transverse to the longitudinal direction 7 as well as possible embodiments of a sealing body arrangement 24.

A lubrication film 29 is formed on the inner surface 12 of the endless band 4, which in an operational status of the endless band is conveyed in the longitudinal direction 7 or a transport direction. The sealing body arrangement 24 serves to laterally limit the fluid 13 and to maintain the pressing pressure 11.

The sealing body arrangement 24 is arranged in the pressing zone 6 at least on the inner surface 12 of the first endless band 4 with respect to a direction transverse to the longitudinal direction 7 at a first edge section 22 and an opposite second edge section 23, which sealing body arrangement 24 is arranged with respect to the longitudinal direction 7 at least over a length of the pressing zone 6. Preferably, the sealing body arrangement 24 may be provided with an anti-friction coating 32 at least with respect to the inner surface 12, or may consist of a material capable of sliding.

In the illustration shown, different embodiments of the sealing body arrangement 24 are shown at the respective edge sections 22, 23.

The left-hand illustration shows a first possible embodiment of a sealing body arrangement 24. The sealing body arrangement 24 may be configured as an elastic seal which contacts the endless band 4, in particular with two areas contacting the inner surface 12 and an opposite outer surface 28, and is preferably integrally configured so that this is also deformed when the endless band 4 is displaced or deformed by the pressing pressure 11 in the direction of the pressing zone 6, as indicated by a stroke-dotted line, whereby a sealing effect is better maintained. The sealing body arrangement may in turn have an anti-friction coating in the area of the inner surface 12 and/or the outer surface 28.

In a further embodiment, as shown in the right-hand illustration, the sealing body arrangement 24 may comprise a pushing device 26, by means of which pushing device 26 a sealing element 36 of the sealing body arrangement 24 may be pushed against the inner surface 12 of the endless band 4. The pressure-exerting device 26 may, for example, be configured as a flexible inflatable body by means of which the sealing body arrangement 24 is pushed against the endless band 4. Alternatively, the sealing element 36 of the sealing body arrangement 24 may itself be formed as an inflatable body, as indicated by a stroke-dotted line, whereby the pressure-exerting device 26a may be arranged in the sealing element 36. Furthermore, the sealing element 36 in the area of the endless band 4 may have a coating capable of sliding or be made of material capable of sliding.

In an advancement, it may be provided that a pushing pressure of the pushing device 26 may be adjusted as a function of the pressing pressure 11 of the pressure-exerting device 10 and/or of a rotational speed of the first endless band 4, wherein in particular the control device 3 may be configured to make this adjustment.

Furthermore, an elastic connecting bar 31 may be arranged between the sealing body arrangement 24 and the pressure-exerting device 10, by means of which elastic connecting bar a contact area between the pressure-exerting device 10 and the sealing body arrangement 24 is sealed, so that a seal is ensured, for example, when the pressure-exerting device 10 is adjusted. For example, an sketched spacer element 14 of the pressure-exerting device 10 may also be connected to the elastic connecting bar 31.

Irrespective of the sealing body arrangement 24 in both edge sections 22, 23, the spacer element 14 may itself comprise a sealing body arrangement 24, or may itself be configured as a sealing body arrangement 24 and comprise, for example, a pushing device 26 and a sealing element 36, as shown, for example, in the right-hand representation, which are, however, arranged transversely to the longitudinal direction 7.

In an alternative embodiment, not shown, a sealing lip may also be formed on the two edge sections 22, 23 at least on the inner surface of the endless band and over the entire circumference with respect to a lateral seal of the belt. FIG. 6 shows a possible embodiment of a device 1 for pressing material 2, in which the device 1 comprises a first endless band 4 and a second endless band 4′ configured as a second pressing means 5; which endless bands 4, 4′ each comprise at least one pressure-exerting device 10, by means of which pressure-exerting device 10 a pressing pressure 11 can be built up on an inner surface 12 of the respective endless band in the direction of the pressing zone 6, wherein by means of each of the pressure-exerting devices 10 at least one fluid 13 can be applied onto the inner surface 12 of the endless bands in the direction of the pressing zone 6, by means of which fluid 13 the pressing pressure 11 can be built up. As described above, spacer elements 14, fluid collectors 27 as well as adjustment devices 19 and other arrangements may be provided, which may be configured identically or differently on both endless bands.

The device may be arranged in a vertical orientation as shown, but also in a horizontal arrangement, similar to FIG. 1.

FIG. 7 shows a possible embodiment of a pressure-exerting device 10, which pressure-exerting device 10 is arranged over the length 25 of the pressing zone 6. In the form shown, the fluid 13 of the pressure-exerting device 10 is gaseous and is applied by a process pressure of the pressure-exerting device 10 onto the inner surface 12 of the endless band 4 in the direction of the pressing zone 6 to build up a pressing pressure 11. In this respect, at least one pressing means 30 may again be provided, by means of which pressing means 30 the process pressure may be monitored and adjusted.

Embodiments of the aforementioned sealing body arrangements 24 may again be provided on the lateral edge sections 22, 23. Preferably, an adjustment device 19 may again be provided, by means of which a distance 20 between the inner surface 12 of the endless band 4 and the pressure-exerting device 10 can be adjusted.

In the embodiment shown, the pressure-exerting device 10 may comprise, for example, several nozzles or other measures known from the prior art for providing compressed air or process gases by means of which the gaseous fluid 13 may be applied in the direction of the pressing zone 6. Several pressure-exerting devices 10 may also be arranged with respect to the longitudinal direction 7 or in a direction transverse to the longitudinal direction 7, as indicated by stroke-dotted lines.

In the embodiment shown, a process chamber may be formed in the area of the pressure-exerting device 10 or around the entire system, especially if special process gases are used.

FIGS. 6 and 7 show a further and possibly independent embodiment of the device 1 or the pressure-exerting device 10, wherein the same reference signs or component designations are used for the same parts as in the previous figures. To avoid unnecessary repetition, reference is made to the detailed description in the preceding figures.

FIG. 8 shows an embodiment of a spacer element 14 in sectional view, in which the spacer element 14 comprises a frame arrangement 38, wherein the frame arrangement 38 is arranged between the pressure-exerting device 10 and the inner surface 12 of the endless band 4 and is provided with at least one fluid passage 39, the fluid passage 39 being formed in the direction, starting from the pressure-exerting device 10, towards the inner surface 12. Preferably, the fluid passage 39 may be configured by means of an opening formed or bordered by the frame.

The frame arrangement 38 may preferably be configured in such a way that the pressure-exerting device 10 can be placed on it or coupled to it, whereby there is a fluid-tight connection between them so that no fluid can escape via its circumference or edge-side connection areas.

Regardless of the configuration of the frame arrangement 38, it may be configured to be height-adjustable with the pressure-exerting device 10 or on its own, again by means of an adjustment device 19.

A further fluid passage 39a may be formed in at least one frame segment 40, for example by means of an opening or a channel.

The frame segments 40a-c form the three visible sections of the frame arrangement 38, with the fourth segment lying outside the image plane due to the section.

In one possible embodiment, it may be provided that the pressure-exerting device 10 is configured such that a separate area 42 is provided in the pressure-exerting device 10 for the frame segment 40, through which area 42 a quantity of fluid can be provided in the direction of the frame segment 40, so that it exits through the further fluid passage 39a.

In this respect, a valve may be arranged to introduce the fluid into the separate area 42 from the pressure-exerting device 10, or the area 42 may be filled with the fluid independently of the pressure-exerting device 10.

Preferably, the pressure-exerting device 10 may be arranged over the entire pressing zone 6, whereby a lubrication film can be formed after the pressing zone 6 on the endless band 4 by means of the further fluid passage 39a in the frame segment 40a or can also serve for lubrication between the frame arrangement 38 and the endless band 4, as indicated by the fluid passage 39b in the frame segment 40c.

A frame segment 40 may also have several fluid passages.

FIG. 9 shows a further possible embodiment of the spacer element 14, in which the spacer element 14 is at least partially formed from a porous material, the porous material being penetrable by the fluid 13 in at least one direction.

For example, a frame segment 40 or a frame section of the frame arrangement 38 described above may also be made of porous material so that the fluid 13 can seep through. A further fluid passage 39a mentioned above may also be formed by the porous material. Furthermore, a previously described area 42 may be provided in the pressure-exerting device 10 for this purpose.

In addition, the spacer element 14 or a part of the frame arrangement 38 may comprise at least one sealing body arrangement 24 independently of the aforementioned porous material, as mentioned at the beginning.

As shown, the sealing body arrangement 24 may in turn comprise a pressure-exerting device 26 and a sealing element 36. The illustrated sealing body arrangement 24 may also be arranged in the frame segment 40a instead of the porous material, so that a lubrication gap can be formed on the inner surface 12 by means of the sealing body arrangement 24.

Anti-friction coatings may also be provided, or the frame segments 40 or the frame arrangement 38 may be made of a material capable of sliding.

FIG. 10 shows a plan view of a possible embodiment of a frame arrangement 38 of a spacer element 14 with the pressure-exerting device not shown, wherein the lateral frame segments 40b and 40d in the first and second edge sections 22, 23 of the endless band 4 may be formed by the sealing body arrangements 24, and the frame segments 40a and 40c arranged transversely to the longitudinal direction 7 are formed, for example, from porous material.

In a further configuration, it may be provided that all frame segments are formed from the porous material. For example, the frame arrangement may be made to “float” relative to the endless band by means of a quantity of fluid that passes through the frame segments or the porous material in the direction of the inner surface of the endless band.

Other combinations from the previous figures are also conceivable. For example, the frame arrangement 38 may consist of 4 sealing body arrangements 24. Furthermore, a sealing body arrangement may be provided to adjust the lubrication gap.

Furthermore, one of the frame segments arranged transversely to the longitudinal direction may also comprise a rolling body as described in FIG. 3.

FIGS. 8 to 10 show further and possibly independent embodiments of the spacer element 14 or the frame arrangement 38, wherein the same reference signs or component designations are again used for the same parts as in the preceding figures. To avoid unnecessary repetition, reference is made to the detailed description in the preceding figures.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions can be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference signs

| | |
|---|---|
| 1 | device |
| 2 | material |
| 3 | control device |
| 4 | first endless band |
| 5 | second pressing means |
| 6 | pressing zone |
| 7 | longitudinal direction |
| 8 | beginning |
| 9 | end |
| 10 | pressure-exerting device |
| 11 | pressing pressure |
| 12 | inner surface |
| 13 | fluid |
| 14 | spacer element |
| 15 | fluid outlet |
| 16 | lubrication gap |
| 17 | gap width |
| 18 | axis of rotation |
| 19 | adjustment device |
| 20 | distance |
| 21 | spacer |
| 22 | first edge section |
| 23 | second edge section |
| 24 | sealing body arrangement |
| 25 | length |
| 26 | pushing device |
| 27 | fluid collector |
| 28 | outer surface |
| 29 | lubrication film |
| 30 | pressure-exerting means |
| 31 | connecting bar |
| 32 | anti-friction coating |
| 33 | outlet opening |
| 34 | width |
| 35 | pressure roller |
| 36 | sealing element |
| 37 | pressure monitoring unit |
| 38 | frame arrangement |
| 39 | fluid passage |
| 40 | frame segment |
| 41 | container |
| 42 | area |

1: A device (1) for pressing material (2), comprising:
a control device (3) for controlling the device (1);
at least one first endless band (4), which first endless band (4) forms a first pressing means
at least one second pressing means (5), in particular a second endless band;
wherein a pressing zone (6) for pressing material (2) is formed between the first endless band (4) and the second pressing means (5) and a longitudinal direction (7) is defined, wherein the longitudinal direction (7) is arranged parallel to the first endless band (4) and in a direction with respect to the pressing zone (6), starting from a beginning (8) of the pressing zone (6) to an end (9) of the pressing zone (6);
at least one pressure-exerting device (10), wherein by means of the pressure-exerting device (10) a pressing pressure (11) can be built up on an inner surface (12) of the at least one first endless band (4) in the direction of the pressing zone (6), which inner surface (12) is directed away with respect to the pressing zone (6);
wherein the pressure-exerting device (10) is designed in such a way that at least one liquid fluid (13), the fluid comprising in particular water or oil, can be applied onto the inner surface (12) of the at least one first endless band (4) in the direction of the pressing zone (6), by means of which fluid (13) the pressing pressure (11) can be built up,
wherein at least one spacer element (14) is provided, wherein the spacer element (14) is located downstream of a fluid outlet (15) of the pressure-exerting device (10) with respect to a flow direction of the fluid (13), by means of which spacer element (14) a lubrication gap (16) can be formed on the inner surface (12) of the endless band (4) for the fluid (13).

2. (canceled)

3: The device (1) according to claim 1, wherein the at least one spacer element (14) comprises a frame arrangement (38), the frame arrangement (38) being arranged between the pressure-exerting device (10) and the inner surface (12) of the endless band (4) and provided with at least one fluid passage (39), the fluid passage (39) being formed in the direction, starting from the pressure-exerting device (10), towards the inner surface (12).

4: The device (1) according to claim 3, wherein the frame arrangement (38) is provided with at least one further fluid passage (39), the at least one further fluid passage (39) being formed in at least one frame segment (40).

5: The device (1) according to claim 1, wherein the spacer element (14) is formed at least partially from a porous material, the porous material being penetrable by the fluid (13) in at least one direction.

6: The device (1) according to claim 1, wherein the at least one spacer element (14) is wedge-shaped with respect to the longitudinal direction (7), wherein a gap width (17) between the spacer element (14) and the inner surface (12) of the first endless band (4) decreases with respect to the longitudinal direction (7).

7: The device (1) according to claim 1, wherein the spacer element (14) comprises a rolling body, in particular a cylindrical roller, which rolling body is rotatably mounted with respect to an axis of rotation (18), which axis of rotation (18) is orthogonal to the longitudinal direction (7) and substantially parallel to the inner surface (12) of the first endless band (4).

8: The device (1) according to claim 1, wherein an adjustment device (19) is provided, a distance (20) between the inner surface (12) of the first endless band (4) and the pressure-exerting device (10) being adjustable by means of the adjustment device (19).

9: The device (1) according to claim 1, wherein the spacer element (14) is height-adjustable, wherein a distance (21) between the spacer element (14) and the inner surface (12) of the first endless band (4) is adjustable.

10: The device (1) according to claim 1, wherein the pressure-exerting device (10) is arranged over the entire pressing zone (6).

11. (canceled)

12: The device (1) according to claim 1, wherein at least one sealing body arrangement (24) is provided at least in the pressing zone (6), which sealing body arrangement (24) is arranged at least on the inner surface (12) of the endless band (4).

13: The device (1) according to claim 12, that wherein the at least one sealing body arrangement (24) is arranged in the pressing zone (6) at least on the inner surface (12) of the first endless band (4) with respect to a direction transverse to the longitudinal direction (7) on a first edge section (22) and an opposite second edge section (23) of the first endless band (4), the sealing body arrangement (24) being arranged with respect to the longitudinal direction (7) at least over a length (25) of the pressing zone (6).

14: The device (1) according to claim 12, that wherein the at least one sealing body arrangement (24) comprises a pushing device (26), wherein the sealing body arrangement (24) can be pressed against the at least one first endless band (4) by means of the pushing device (26).

15: The device (1) according to claim 12, that wherein the spacer element (14) comprises the at least one sealing body arrangement (24).

16: The device (1) according to claim 1, wherein the control device (3) is configured to adjust the pressing pressure (11) of the pressure-exerting device (10) depending on a rotational speed of the first endless band (4).

17: The device (1) according to claim 8, wherein the control device (3) is configured to adjust the distance (20) between the inner surface (12) of the at least one first endless band (4) and the pressure-exerting device (10) depending on a rotational speed of the first endless band (4).

18: The device (1) according to claim 10, wherein the control device (3) is configured to control a pushing pressure of the pushing device (26) on the sealing body arrangement (24) depending on the pressing pressure (11) of the pressure-exerting device (10) and/or a quantity of fluid introduced into the lubrication gap (16) and serving as lubricant.
